(19) United States
(12) Patent Application Publication
(10) Pub. No.: US 2017/0178586 A1
(43) Pub. Date: Jun. 22, 2017

(54) DISPLAY APPARATUS AND TILED DISPLAY APPARATUS

(71) Applicant: ELECTRONICS AND TELECOMMUNICATIONS RESEARCH INSTITUTE, Daejeon (KR)

(72) Inventors: Tae-Youb KIM, Daejeon (KR); Chunwon BYUN, Daejeon (KR); Chi-Sun HWANG, Daejeon (KR); Yong Hae KIM, Daejeon (KR); Jae-Eun PI, Daejeon (KR); Hojun RYU, Seoul (KR); Seong-Mok CHO, Daejeon (KR)

(21) Appl. No.: 15/224,208

(22) Filed: Jul. 29, 2016

(30) Foreign Application Priority Data
Dec. 22, 2015 (KR) 10-2015-0183945
Feb. 19, 2016 (KR) 10-2016-0019707

(51) Int. Cl. G09G 3/36; G03H 1/00; G06F 3/14; G09G 3/00; G02F 1/1368; G02F 1/1362

(52) U.S. Cl. CPC G09G 3/3688; G09G 3/3659; G02F 1/1368; G02F 1/136227; G06F 3/1446; G09G 3/003; G03H 1/0005; G09G 2300/0408; G09G 2300/08; G09G 2300/026

(57) ABSTRACT

A display apparatus may include: a first base substrate; a driving circuit unit disposed on the first base substrate and including a plurality of gate lines, a plurality of data lines and a plurality of thin film transistors electrically connected to the plurality of gate lines and the plurality of data lines; a driving circuit controller including a gate driver disposed between the driving circuit unit and the first base substrate and outputting a gate signal to the gate lines, a data driver outputting a data voltage to the plurality of data lines and an interface circuit unit controlling operation timings of the gate driver and the data driver; and an image embodying unit disposed on the driving circuit unit and embodying an image in response to a signal received from the driving circuit unit.

### CROSS-REFERENCE TO RELATED APPLICATIONS

This U.S. non-provisional patent application claims priorities under 35 U.S.C. §119 of Korean Patent Application Nos. 10-2015-0183945, filed on Dec. 22, 2015, and 10-2016-0019707, filed on Feb. 19, 2016, the entire contents of which are hereby incorporated by reference.

### BACKGROUND

The present disclosure relates to a display apparatus and a tiled display apparatus, and more particularly, to a display apparatus and a tiled display apparatus which have a reduced width in a bezel area and are easily expandable in size.

A display panel (or a spatial light modulator for embodying a hologram image) may include a plurality of pixels, a plurality of gate lines and a plurality of data lines. The plurality of pixels are arranged in a matrix form, and each of the plurality of pixels may be electrically connected to one of the gate lines and one of the data lines. The number of pixels that can be driven by each of one of the data lines and one of the gate lines may be limited. Thus, one display apparatus may use a plurality of display panels to enlarge the size of a displayed image.

A gate driver for driving the plurality of gate lines and a data driver for driving the plurality of data lines may be disposed on one side and another side of a display panel. Thus, when the plurality of display panels are arranged in a tiled shape for use, the positions of the gate driver and the data driver may be changed to minimize a gap of a non-display area between one display panel and another display panel. The display panel may be easily expanded to twice its original size in each of a row direction and a column direction, but is hard to be expanded to three times or more its original size in each of the row and column directions. Thus, the display apparatus may be limited in expanding the size and resolution thereof Thus, technical means to easily expand the size of the display apparatus is required.

### SUMMARY

The present disclosure provides a display apparatus and a tiled display apparatus which have a reduced width in a bezel area, and are easily expandable in size thereof.

A display apparatus according to an embodiment may include: a first base substrate; a driving circuit unit disposed on the base substrate and including a plurality of gate lines, a plurality of data lines and plurality of thin film transistors electrically connected to the plurality of gate lines and the plurality of data lines; a driving circuit controller disposed between the first substrate and the driving circuit unit and including a gate driver outputting a gate signal to the plurality of gate lines, a data driver outputting a data voltage to the plurality of data lines and an interface circuit unit controlling operation timings of the gate driver and the data driver; and an image embodying unit disposed on the driving circuit unit and embodying an image in response to a signal received from the driving circuit unit.

In an embodiment, a display apparatus may further include an insulation layer disposed between the driving circuit unit and the driving circuit controller, and the driving circuit unit and the driving circuit controller may be electrically connected through a through hole formed in the insulation layer.

In an embodiment, the driving circuit controller may further include a plurality of gate terminals extending from the gate driver, and a plurality of data terminals extending from the data driver, and each of the plurality of gate terminals and each of the plurality of gate lines may be electrically connected through the through hole, and each of the plurality of data terminals and each of the plurality of data lines may be electrically connected through the through hole.

In an embodiment, the display apparatus may further include a second base substrate disposed between the driving circuit unit and the driving circuit controller, and the driving circuit unit and the image embodying unit may be disposed on the second base substrate, the driving circuit controller may be disposed on the first base substrate, and the driving circuit unit may be electrically connected to the driving circuit controller through a through hole formed in the second base substrate.

In an embodiment, the image embodying unit may include a pixel electrode electrically connected to one thin film transistor of the plurality of thin film transistors, a liquid display layer disposed on the pixel electrode, and a common electrode forming an electric field in the liquid crystal layer together with the pixel electrode.

In an embodiment, the pixel electrode may include a reflective material.

In an embodiment, the image embodying unit may output a hologram image.

In an embodiment, the image embodying unit may be divided in a display area embodying the image and a non-display area adjacent to the display area, and the driving circuit unit and the driving circuit controller may be disposed between the display area and the first base substrate.

A tiled display apparatus according to an embodiment may include a plurality of display panels arranged along a first direction and a second direction crossing the first direction, and each of the plurality of display panels may include a driving circuit unit including a plurality of gate lines, a plurality of data lines, and a plurality of thin film transistors electrically connected to the plurality of gate lines and the plurality of data lines, a driving circuit controller disposed under the driving circuit unit and including a gate driver outputting a gate signal to the plurality of gate lines, a data driver outputting a data voltage to the plurality of data lines, and an interface circuit unit controlling operation timings of the gate driver and the data driver, and an image embodying unit disposed on the driving circuit unit and embodying an image in response to a signal received from the driving circuit unit.

In an embodiment, the driving circuit controller may further include a plurality of contact terminals extending from the interface circuit unit, and display panels adjacent to each other among the plurality of display panels may be electrically connected through the contact terminals.

In an embodiment, the contact terminals may include a first contact terminal extending along the first direction from the interface circuit unit, a second contact terminal extending along the second direction from the interface circuit unit, a third contact terminal extending along a direction completely opposite to the first direction from the interface circuit unit, and a fourth connection terminal extending along a direction completely opposite to the second direction from the interface circuit unit.

In an embodiment, the tiled display apparatus may further include a light source emitting light, and each of the plurality of display panels may be a spatial light modulator modulating at least one of phase or amplitude of the light emitted from the light source to output a hologram image.

Each of the plurality of display panels may further include a first base substrate and a second base substrate, the driving circuit controller may be disposed on the first base substrate, the driving circuit may be disposed on the driving circuit controller, the image embodying unit may be disposed on the driving circuit unit, and the second base substrate may be disposed on the image embodying unit.

In an embodiment, display panels adjacent to each other among the plurality of display panels may include one first base substrate and one second base substrate, and the driving circuit controller of each of the adjacent display panels, the driving circuit unit of each of the adjacent display panels and the image embodying unit of each of the adjacent display panels may be disposed between the one first base substrate and the one second base substrate.

In an embodiment, each of the plurality of display panels may further include an insulation layer disposed between the driving circuit unit and the driving circuit controller, and the driving circuit unit and the driving circuit controller may be electrically connected through a through hole formed in the insulation layer.

In an embodiment, each of the data lines and each of the gate lines may extend along a predetermined direction in a plane defined by the first and second directions, and the through hole may extend along a third direction crossing the first and second directions.

### BRIEF DESCRIPTION OF THE FIGURES

The accompanying drawings are included to provide a further understanding of the inventive concept, and are incorporated in and constitute a part of this specification. The drawings illustrate exemplary embodiments of the inventive concept and, together with the description, serve to explain principles of the inventive concept. In the drawings:

FIG. 1 is a plane view of a display apparatus according to an embodiment of the inventive concept;

FIG. 2 is a schematic exploded perspective view of the display apparatus of FIG. 1;

FIG. 3 is an enlarged plane view of a portion of a display panel;

FIG. 4 is a cross-sectional view of the display panel taken along a line I-I′ of FIG. 3;

FIGS. 5 a cross-sectional view schematically illustrating a driving circuit controller of a display apparatus;

FIG. 6 is a schematic diagram of a holographic display apparatus capable of displaying a hologram image according to an embodiment;

FIG. 7 is a schematic exploded perspective view of a display apparatus according to an embodiment; and

FIG. 8 is a schematic exploded perspective view of a display panel according to an embodiment.

### DETAILED DESCRIPTION

The embodiments according to the inventive concept may be variously modified and may have multiple forms, and thus specific embodiments are illustrated in the drawings or described in detail in this specification. However, this is not intended to limit the inventive concept to the specific embodiments, rather it should be understood that all of variations, equivalents or substitutes contained in the concept and technical scope of the present disclosure are also included. Also, in the drawings, descriptions about elements not related to the inventive concept are omitted for clarity.

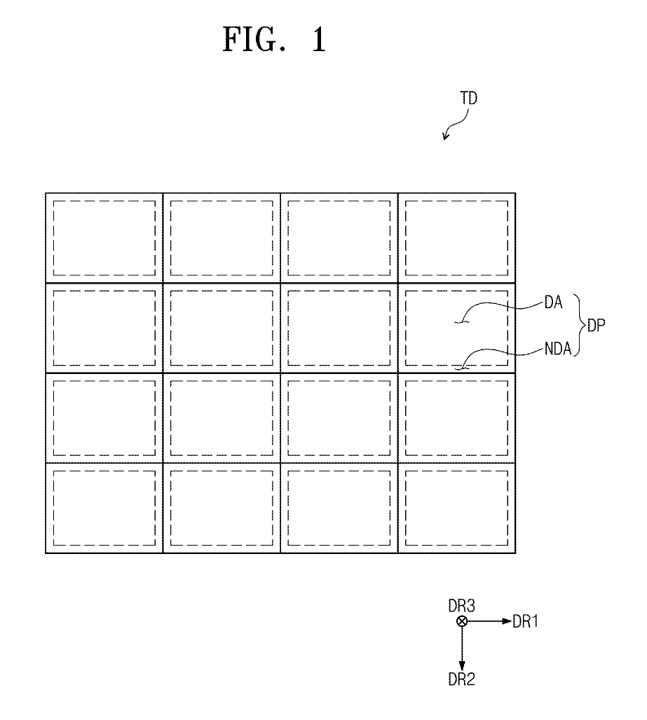

FIG. 1 is a plane view of a display apparatus according to an embodiment of the inventive concept.

Referring to FIG. 1, a display apparatus TD may be a tiled display apparatus. The display apparatus TD may include a plurality of display panels DP. The plurality of display panels DP may be arranged in a matrix form. For example, the display panels DP may be arranged along a first direction DR1 and a second direction DR2 crossing the first direction DR1. In FIG. 1, total 16 display panels DP including 4 display panels in the first direction DR1 and 4 display panels in the second directions DR2 of the display panels DP are exemplified, but the number of the display panels is not limited thereto. For example, the display panel DP may be arranged by one or more in the first direction DR1 and by one or more in the second direction DR2. That is, in another embodiment, the display apparatus TD may include only one display panel DP. Also, the display panels DP may be arranged in parallel in the first direction DR1 only. The display panels DP may be arranged in various shapes such as a cross shape, a pyramid shape in addition to a rectangular shape.

The display apparatus TD may be large electronic equipment such as a TV set or an outdoor advertisement board, or hologram electronic equipment including a plurality of display panels DP. These are presented as an embodiment only, and it is apparent that the display apparatus TD may be adopted in other electronic apparatuses without departing the inventive concept.

Each of the display panels DP may be shaped in a rectangle having a pair of long sides extending in a first direction DR1 and another pair of short sides extending in a second direction DR2. A third direction DR3 perpendicular to each of the first and second directions DR and DR2 indicates a thickness direction of each of the display panels DP.

Each of the display panels DP includes a plurality of areas divided on a display surface. Each of the display panels DP may be divided into a display area DA and a non-display area NDA according to whether or not capable of embodying an image. The display area DA is an area in which the image may be implemented, while the non-display area NDA is an area neighboring to the display area DA and in which the image is not displayed.

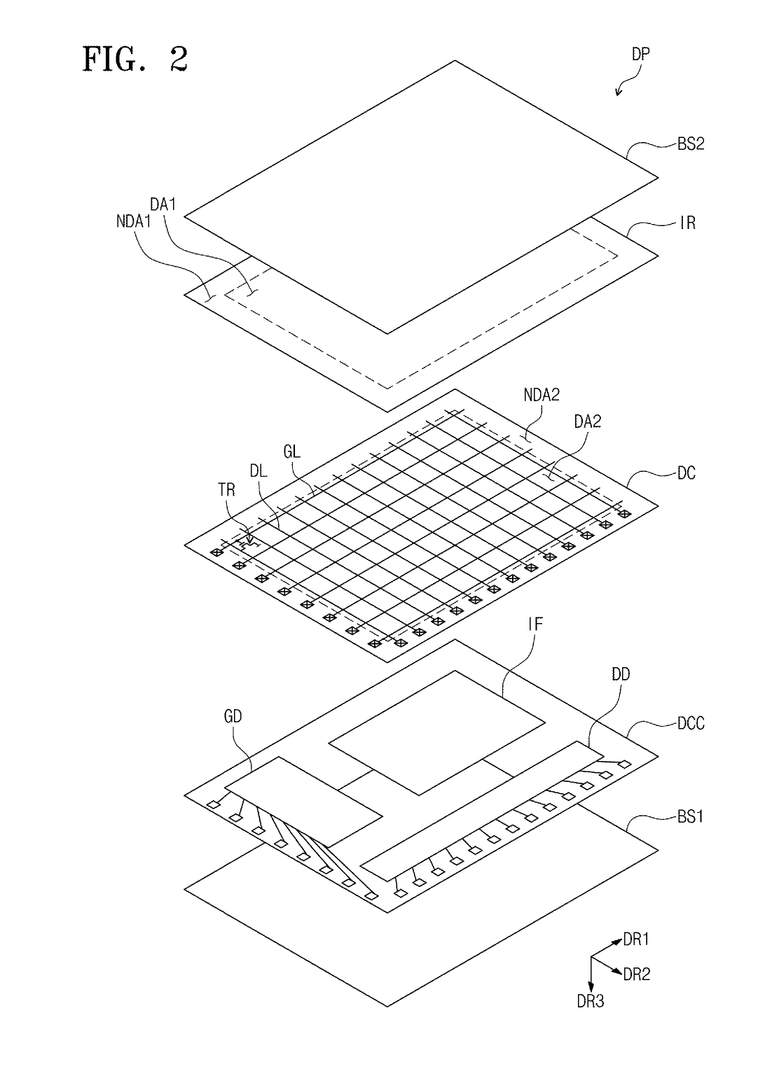

FIG. 2 is a schematic exploded perspective view of one display panel of FIG. 1.

Referring to FIG. 2, a display panel DP may include a first base substrate BS1, a second base substrate BS2, an image embodying unit IR, a driving circuit unit DC and a driving circuit controller DCC.

The first and second base substrates BS1 and BS2 may face each other. Between the first and second base substrates BS1 and BS2, the image embodying unit IR, the driving circuit unit DC and the driving circuit controller DCC may be sequentially disposed. For example, the image embodying unit IR may be disposed under the second base substrate BS2, the driving circuit unit DC for driving the image embodying unit IR may be disposed under the image embodying unit IR, and the driving circuit controller DCC for transmitting a signal to the driving circuit unit DC may be disposed under the driving circuit unit DC.

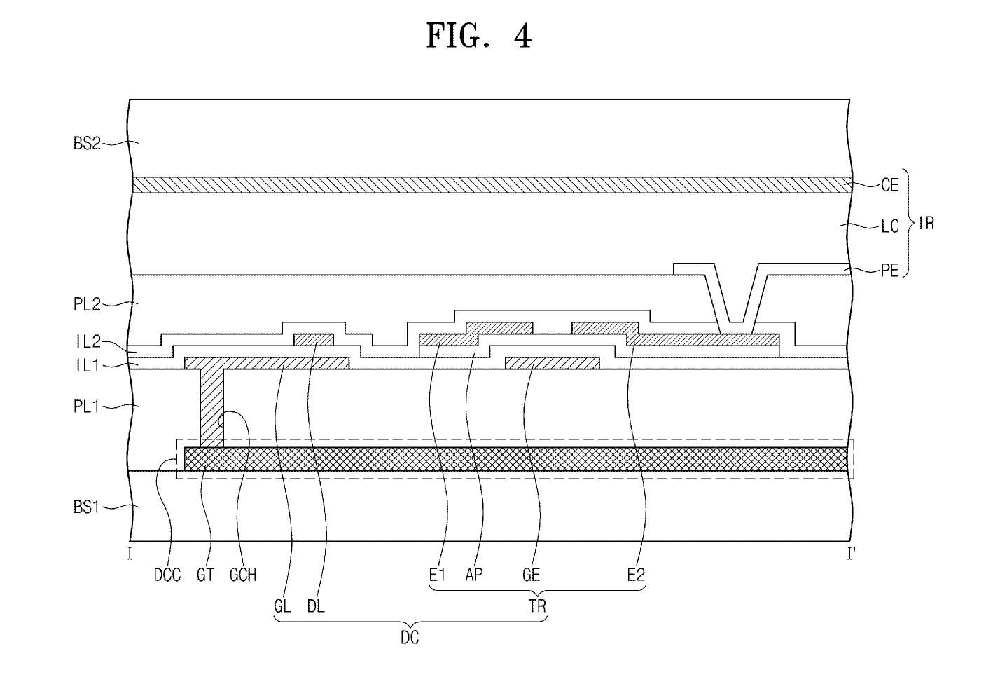

The image embodying unit IR may embody an image in response to a signal received from the driving circuit unit DC. For example, the image embodying unit IR may display a general image or output a hologram image by modulating at least one of phase or amplitude of a light. Description for constituents of the image embodying unit IR will be provided in more detail in FIG. 4.

The driving circuit unit DC may include a plurality of gate lines GL, a plurality of data lines DL, and a plurality of thin film transistors TR. Each of the plurality of gate lines GL may extend along a first direction DR1, and each of the plurality of data lines DL may extend in a second direction DR2. Each of the thin film transistors TR may be connected to one gate line GL and one data line DL. A control electrode of the thin film transistor TR is connected to the gate line GL, a first electrode of the thin film transistor TR is connected to the data line DL, and a second electrode of the thin film transistor TR may be connected to the image embodying unit IR.

The image embodying unit IR may include a display area DA1 in which an image is displayed and a non-display area NDA1 adjacent to the display area DA1. The driving circuit unit DC may include a display area DA2 corresponding to the display area DA1 of the image embodying unit IR, and a non-display area NDA2 corresponding to the non-display area NDA1 of the image embodying unit IR. The display area DA1 of the image embodying unit IR and the display area DA2 of the driving circuit unit DC may correspond to a display area (DA of FIG. 1) of the display panel DP.

According to an embodiment, the driving circuit controller DCC may be disposed under the driving circuit unit DC. The driving circuit controller DCC may include a gate driver GD, a data driver DD and an interface circuit unit IF. When the display panel DP is viewed from a third direction DR3, which is a thickness direction, the gate driver GD, the data driver DD and the interface circuit unit IF may overlap the display area (DP of FIG. 1) of the display panel DP.

The gate driver GD, the data driver DD and the interface circuit unit IF may be provided in the form of a circuit under the driving circuit unit DC. For example, unlike an embodiment, when the driving circuit controller DCC is disposed on the same layer as the driving circuit unit DC, the non-display area NDA2 may be enlarged by the driving circuit controller DCC. However, according to an embodiment, the driving circuit controller DCC and the driving circuit unit DC are disposed on different layers from each other. Accordingly, the width of the non-display area NDA2 may be further reduced than when the driving circuit controller DCC and the driving circuit unit DC are disposed on the same layer. Also, when the driving circuit controller DCC is disposed on the same layer as the controller circuit DC, a process to reduce the size of the driving circuit controller DCC is essential. However, according to an embodiment, the process to reduce the size of the driving circuit controller DCC is not essential since the width of the non-display area NDA2 is not determined by the driving circuit controller DCC. Accordingly, the size of each unit circuit constituting the driving circuit controller DCC is not necessarily reduced, and thus the process of forming the driving circuit controller DCC may become easier.

The interface circuit unit IF receives a plurality of control signals and a data signal from the outside of the display apparatus (TD of FIG. 1). The interface circuit unit IF generates a gate control signal and a data control signal in response to the control signals provided from the outside. Also, the interface circuit unit IF converts the data signal to be matched with the specification of the data driver DD, and may output the converted data signal to the data driver DD.

The gate control signal is a control signal to control an operation timing of the gate driver GD. The interface circuit unit IF may output the gate control signal to the gate driver GD. The data control signal is a control signal to control an operation timing of the data driver DD. The interface circuit unit IF may output the data control signal to the data driver DD.

The gate driver GD outputs gate signals in response to the gate control signal. The gate lines GL receive the gate signals from the gate driver GD. The gate signals are provided to the thin film transistor TR of the driving circuit unit DC through the gate lines GL.

The data driver DD generates a data voltage. More specifically, the data driver DD converts the converted data signal to the data voltage and outputs the same in response to the data control signal.

The driver circuit controller DCC may further include a gate terminal GT extending from the gate driver GD, and a data terminal DT extending from the data driver DD. The number of the gate terminals GT may be substantially same as the number of the gate lines GL, and the number of the data terminals DT may be substantially same as the number of the data lines DL, but are not limited thereto.

A gate contact hole GCH may be provided to one end of each of the gate lines GL of the driving circuit unit DC. A conductive material may be filled in the gate contact hole GCH. Thus, each of the gate lines GL may be electrically connected to each of the gate terminals GT of the driver circuit controller DCC disposed thereunder trough the gate contact hole GCH. A data contact hole DCH may be provided to one end of each of the data lines DL of the driving circuit unit DC. The conductive material may be filled in the data contact hole DCH. Thus, each of the data lines DL may be electrically connected to the data terminal DT of the driving circuit controller DCC disposed thereunder through the data contact hole DCH. That is, although the driving circuit unit DC and the driving circuit controller DCC are disposed on a different layer from each other, the driving circuit unit DC and the driving circuit controller DCC may be electrically connected to each other through the conductive material filled in the gate contact hole GCH and the data contact hole DCH.

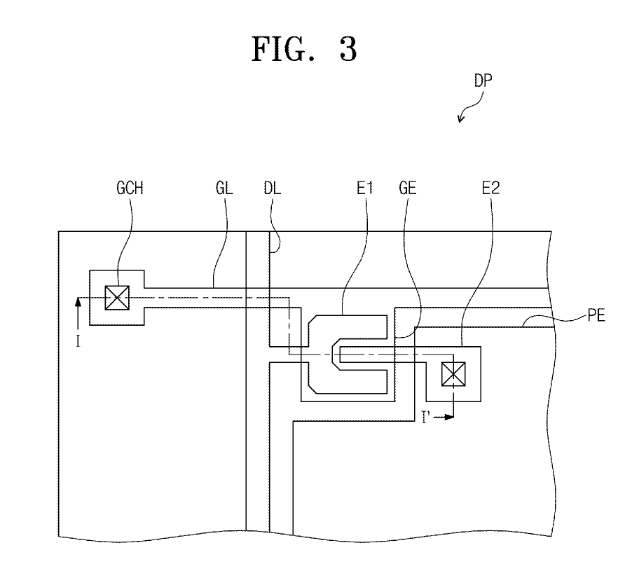

FIG. 3 is an enlarged plane view of a portion of a display panel, and FIG. 4 is a cross-sectional view of the display panel taken along line I-I′ of FIG. 3.

Referring to FIGS. 3 and 4, an image embodying unit IR, a driving circuit unit DC and a driving circuit controller DCC may be disposed between a first base substrate BS2 and a second base substrate BS2.

The driving circuit controller DCC may be disposed on the first base substrate BS1, the driving circuit unit DC may be disposed on the driving circuit controller DCC, and the image embodying unit IR may be disposed on the driving circuit unit DC. That is, in this embodiment, the driving circuit unit DC and the driving circuit controller DCC may be disposed on different layers from each other.

An insulation layer PL1 may be disposed between the driving circuit unit DC and the driving circuit controller DCC. A gate line GL of the driving circuit unit DC may be electrically connected to a gate terminal GT through a gate contact hole GCH formed to penetrate the insulation layer PL1. Although not illustrated, a data line DL of the driving circuit unit DC may also be electrically connected to the data terminal (DT of FIG. 2) through the data contact hole (DCH of FIG. 2) formed to penetrate the insulation layer PL1.

That is, since the driving circuit controller DCC is disposed under the driving circuit unit DC, it is required that the non-display area (NDA of FIG. 2) secure an area in which the gate contact hole GCH and the data contact hole (DCH of FIG. 2) are to be disposed. Thus, unlike an embodiment, the width of the non-display area (NDA of FIG. 2) may be further reduced when the driving circuit controller DCC is disposed under the driving circuit unit DC than when the driving circuit controller DCC is mounted on the non-display area (NDA of FIG. 2) on the same layer as the driving circuit unit DC.

A thin film transistor TR may be disposed on the insulation layer PL1. The thin film transistor TR may include a gate electrode GE, an active pattern AP, a first electrode E1 and a second electrode E2. The gate electrode GE may be branched from the gate line GL. The active pattern AP may be disposed on the gate electrode GE having a first insulation layer IL1 therebetween. The first electrode E1 may be branched from the data line DL to contact the active pattern AP, and the second electrode E2 may be spaced from the first electrode E1 to contact the active pattern AP. A second insulation layer IL2 may cover the thin film transistor TR. A planarization layer PL2 may be disposed on the second insulation layer IL2.

An image embodying unit IR may be disposed on the planarization layer PL2. The image embodying unit IR may include a pixel electrode PE, a liquid crystal layer LC and a common electrode CE. In this embodiment, the image embodying unit IR is exemplified to embody an image using a liquid crystal, but not limited thereto. For example, in another embodiment, the image embodying unit IR may include an organic light-emitting material.

The pixel electrode PE may be disposed on the planarization layer PL2. The pixel electrode PE may be electrically connected to the second electrode E2 through a contact hole formed to penetrate the planarization layer PL2. The pixel electrode PE may include a light-reflective material. For example, the pixel electrode PE may include Al, Mo or the like, but not limited thereto.

The common electrode CE may face the pixel electrode PE having a liquid crystal layer LC therebetween. For example, the common electrode CE may include an oxide such as ITO, SnO₂, ZnO₂ or the like, but not limited thereto.

The liquid crystal layer LC may be disposed between the pixel electrode PE and the common electrode CE. The liquid crystal layer LC may include liquid crystal molecules (not illustrated) arranged in a predetermined form. The pixel electrode PE and the common electrode CE may form an electric field in the liquid crystal layer LC. However, the embodiment of the inventive concept is not limited thereto. For example, the pixel electrode PE and the common electrode CE may also be disposed on a same plane, or the pixel electrode PE and the common electrode CE may also be disposed on different planes spaced apart by a predetermined distance as viewed in a cross-section. In this case, the pixel electrode PE and the common electrode CE may form the electric field in the liquid crystal layer LC by a horizontal electric field method.

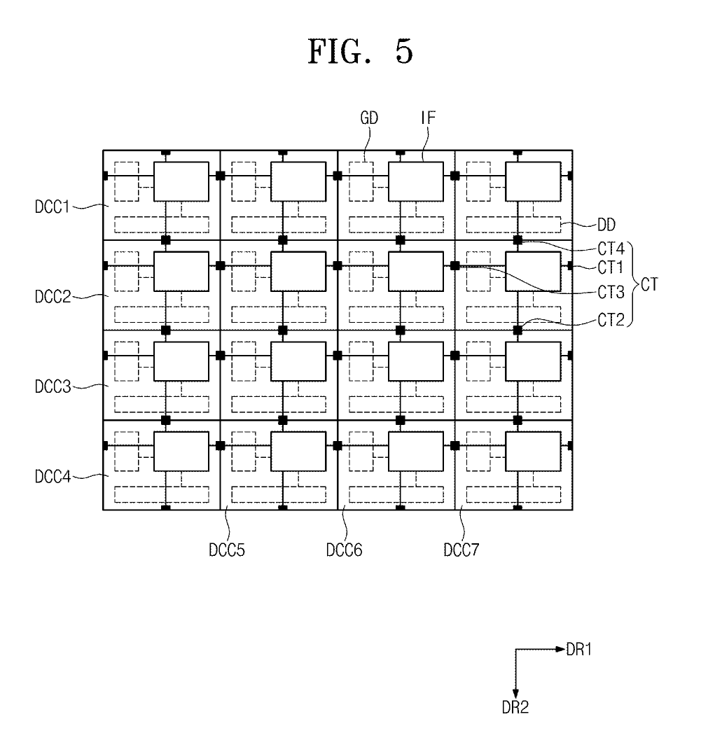

FIG. 5 is a cross-sectional view schematically illustrating a driving circuit controller of a display apparatus.

Referring to FIG. 5, as described in FIG. 1, since the display apparatus (TD of FIG. 1) includes the plurality of display panels (DP of FIG. 1), the display apparatus (TD of FIG. 1) may include a plurality of driving circuit controllers DCCs.

Each of the plurality of driving circuit controllers DCC may include contact terminals CT extending from the interface circuit unit IF. The contact terminals CT may include a first contact terminal CT1, a second contact terminal CT2, a third contact terminal CT3, and a fourth contact terminal CT4.

The first contact terminal CT1 may extend along a first direction DR1 from the interface circuit unit IF, and the second contact terminal CT2 may extend along a second direction DR2 from the interface circuit unit IF. The third contact terminal CT3 may extend along a direction completely opposite to the first direction DR1 from the interface circuit unit IF, and the fourth contact terminal CT4 may extend along a direction completely opposite to the second direction DR2 from the interface circuit unit IF.

The interface circuit unit IF may be electrically connected to an adjacent interface circuit unit IF through the contact terminals CT. For example, the first and third contact terminals CT1 and CT3 may be disposed on a same line, and the second and fourth contact terminals CT2 and CT4 may be disposed on a same line. Thus, the first contact terminal CT1 of one interface circuit unit IF may be electrically connected to the third contact terminal CT3 of an adjacent interface circuit unit IF placed next to the first contact terminal CT1 along the first direction DR1. More specifically, for example, a fourth driving circuit controller DCC4 may be electrically connected to a fifth driving circuit controller DCC5. In this case, a first contact terminal CT1 of the fourth driving circuit controller DCC4 may be electrically connected to a third contact terminal CT3 of the fifth driving circuit controller DCC5.

Driving circuit controllers disposed outermost, among the driving circuit controllers DCCs, may be electrically connected to an external module control circuit (not illustrated). For example, third contact terminals CT3 of each of a first driving circuit controller DCC1, a second driving circuit controller DCC2, a third driving circuit controller DCC3, and a fourth driving circuit controller DCC4 that are disposed in parallel with each other along the second direction DR2 may be connected to the module control circuit. Also, a second contact terminal CT2 of each of the fourth driving circuit controller DCC4, the fifth driving circuit controller DCC5, a sixth driving circuit controller DCC6, a seventh driving circuit controller DCC7 may be connected to the module control circuit.

The interface circuit units IFs of the first to seventh driving circuit controllers DCC1 to DCC7 may receive a plurality of control signals and data signals from the module control circuit, but the inventive concept is not limited thereto. For example, only one of the driving circuit controllers DCCs may receive the signal from the module control circuit, and may deliver the received signal to other driving circuit controllers. Also, the first to fourth driving circuit controllers DCC1 to DCC4 may receive the signals from the module control circuit, and may deliver the received signals to other driving circuit controllers arranged in the first direction DR1.

Since the driving circuit controller DCC is disposed under the driving circuit unit (DC of FIG. 2) and may deliver a signal in each direction through the contact terminals CT, the display panel (DP of FIG. 1) may be added in various directions on the basis of one display panel (DP of FIG. 1). Thus, the size of the display apparatus (TD of FIG. 1) may be easily expanded regardless of a direction in which the display panel (DP of FIG. 1) is disposed.

While this embodiment exemplarily illustrates that four contract terminals CT1, CT2, CT3 and CT4 extend from one interface circuit unit IF, the inventive concept is not limited thereto. For example, in another embodiment, a driving circuit controller DCC may only include a contact terminal extending in one direction from an interface circuit unit IF and another contact terminal extending in another direction completely opposite to the one direction. In this case, a signal may be delivered in two directions not in four directions.

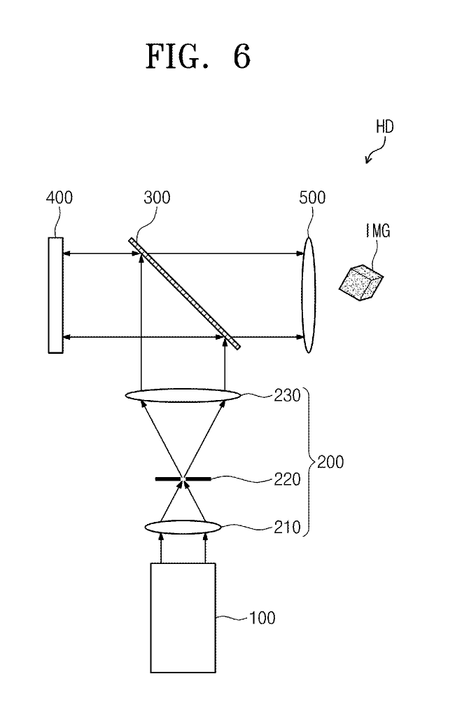

FIG. 6 is a schematic diagram of a holographic display apparatus capable of displaying a hologram image according to an embodiment.

Referring to FIGS. 1 and 6, a holographic display apparatus HD may include a light source 100, a first optical system 200, a beam divider 300, a spatial light modulation unit 400 and a second optical system 500.

The light source 100 emits a light. The light source 100 may be a laser light source or LED light source generating a laser beam having a coherent property.

The first optical system 200 provides a light emitted from the light source 100 to the beam divider 300. The first optical system 200 performs a function of evenly emitting the emitted light from the light source 100 to a front surface of the beam divider 300.

The first optical system 200 may include a focusing lens 210, a filter 220 and an expansion lens 230. The light passing through the focusing lens 210 may pass through a pin hole HL of the filter 220. The light passing through the pin hole HL of the filter 220 is increased in diameter thereof while passing through the expansion lens 230, and may be evenly incident to the front surface of the beam divider 300. Distances between the focusing lens 210, the filter 220 and the expansion lens 230 may be properly adjusted.

The beam divider 300 may emit the light incident thereto to the spatial light modulation unit 400. The beam divider 300 creates interference between the light reflected from the spatial light modulation unit 400 and the light incident from the first optical system 200, and emits the same to the second optical system 500.

The spatial light modulation unit 400 may display a hologram image IMG by modulating the incident light. The spatial light modulation unit 400 may modulate at least one of phase and amplitude to display the hologram image IMG while reflecting the incident light.

In this embodiment, the spatial light modulation unit 400 may be the tiled display apparatus TD previously described with reference to FIG. 1. That is, as the tiled display apparatus TD includes the plurality of display panels DP, the spatial light modulation unit 400 may include a plurality of spatial light modulators DP.

The display apparatus TD illustrated in FIG. 1 may be substantially the same as the spatial light modulation unit 400, and the display panel DP may be referred to as the spatial light modulator DP.

As a pixel pitch of the spatial light modulator DP is gradually reduced in order to obtain a hologram image having a wide viewing angle, the size of the spatial light modulator DP may be accordingly reduced. That is, in a ultra high resolution spatial light modulator DP, when the pixel pitch is reduced, the size of the spatial light modulator DP may be reduced because the number of pixels driven by one driver (i.e., a gate driver or a data driver) driving the pixels is limited.

According to an embodiment, one spatial light modulation unit 400 is embodied using a plurality of spatial light modulators DP. Accordingly, while embodying a ultra high resolution spatial light modulation unit 400 having a pixel size of approximately 1 μm, the size of the light modulation unit 400 may be expanded at the same time. Consequently, the viewing angle and size of the hologram image may be expanded.

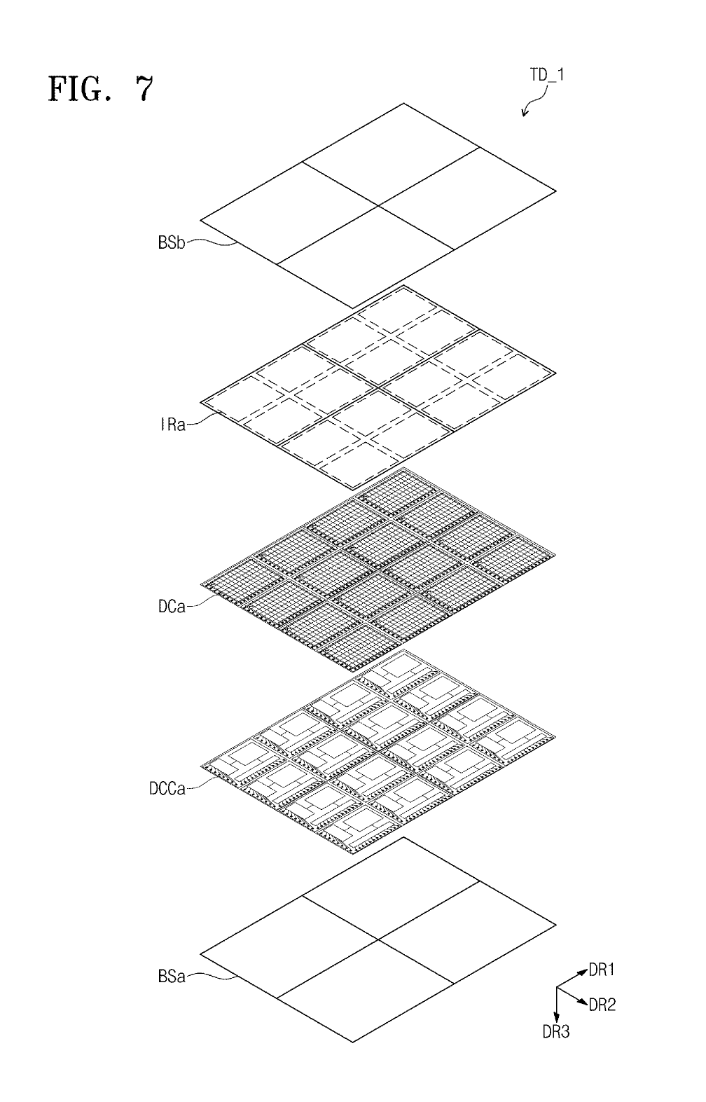

FIG. 7 is a schematic exploded perspective view of a display apparatus according to an embodiment. In FIG. 7, differences from a comparison with the foregoing display apparatus TD will be specifically described.

Referring to FIG. 2, in the display panel DP constituting the display apparatus TD, one driving circuit controller DCC, one driving circuit unit DC and one image embodying unit IR are disposed between the first base substrate BS1 and the second base substrate BS2. Referring to FIG. 7, however, a plurality of driving circuit controllers DCCa, a plurality of driving circuits DCa and a plurality of image embodying units IRa maybe disposed between a first base substrate BSa and a second base substrate BSb.

For example, in FIG. 7, a structure in which four driving circuit controllers DCCa, four driving circuits DCa and four image embodying units IRa are sequentially disposed on the first base substrate BSa is exemplarily illustrated. However, the inventive concept is not limited thereto. In another embodiment, the number of the driving circuit controllers DCCa, the driving circuit units DCa and the image embodying units IRa to be disposed between the first and second base substrates BS1 and BS2 may be adjusted according to the size and intended use of the first and second base substrates BS1 and BS2.

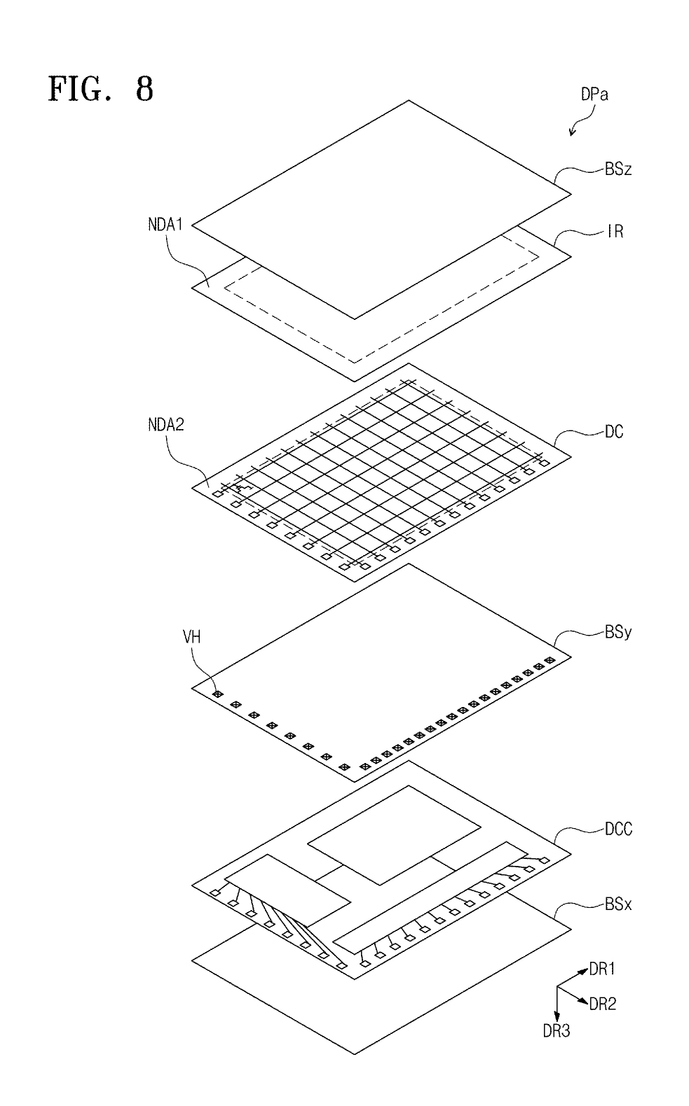

FIG. 8 is a schematic exploded perspective view of a display panel according to an embodiment. In FIG. 8, differences from a comparison with the foregoing display panel DP will be specifically described.

Referring to FIG. 8, a display panel DPa may include a first base substrate BSy, a third base substrate BSz, a driving circuit controller DCC, a driving circuit unit DC and an image embodying unit IR.

The second base substrate BSy may be disposed between the first base substrate BSx and the third base substrate BSz. The driving circuit controller may be disposed between the first base substrate BSx and the second base substrate BSy. The driving circuit unit DC and the image embodying unit IR may be disposed between the second base substrate BSy and the third base substrate BSz.

That is, the driving circuit controller DCC may be disposed on the first base substrate BSx, and the driving circuit unit DC may be disposed on the second base substrate BSy. Thus, the second base substrate BSy may be disposed between the driving circuit unit DC and the driving circuit controller DCC. A through hole VH may be provided in the second base substrate BSy. A conductive material may be filled in the through hole VH, and consequently, the driving circuit unit DC and the driving circuit controller DCC may be electrically connected to each other.

According to an embodiment, the driving circuit controller DCC is disposed under the driving circuit unit DC, and thus the width of the non-display area NDA2 may be reduced. Also, the area when the driving circuit controller DCC is disposed under the driving circuit unit DC is wider than when the driving circuit controller DCC is mounted on the non-display area NDA2 which is the same layer on which the driving circuit unit DC is disposed. Thus, since there is no need to reduce the size of each of unit circuits constituting the driving circuit controller DCC, a process of forming the driving circuit controller DCC may thus become easier.

According to a display apparatus and a tile display apparatus according to the present disclosure, a gate line and a data line are disposed on a gate driver and a data driver. Thus, a separate area for disposing the gate driver or the data driver around a display area may be omitted. Consequently, a bezel area, i.e., the width of a non-display area may be reduced. Also, when one display apparatus is embodied using a plurality of display panels, the display apparatus may also be easily expanded without limitation in direction in which the display panel is disposed.

While the present disclosure has been particularly shown and described with reference to exemplary embodiments thereof, it will be understood by those of ordinary skilled in the art that various changes may be made therein without departing from the scope of the present disclosure as defined by the following claims. Therefore, technical scope of the present disclosure should not be construed as limited to those described in the description, but be determined by the appended claims.

What is claimed is:

1. A display apparatus comprising:
a first base substrate;
a driving circuit unit disposed on the first base substrate and including a plurality of gate lines, a plurality of data lines and a plurality of thin film transistors electrically connected to the plurality of gate lines and the plurality of data lines;
a driving circuit controller disposed between the first substrate and the driving circuit unit and including a gate driver outputting a gate signal to the plurality of gate lines, a data driver outputting a data voltage to the plurality of data lines and an interface circuit unit controlling operation timings of the gate driver and the data driver; and
an image embodying unit disposed on the driving circuit unit and embodying an image in response to a signal received from the driving circuit unit.

2. The display apparatus of claim 1, further comprising an insulation layer disposed between the driving circuit unit and the driving circuit controller, wherein the driving circuit unit and the driving circuit controller are electrically connected through a through hole formed in the insulation layer.

3. The display apparatus of claim 2, wherein the driving circuit controller further comprises:
a plurality of gate terminals extending from the gate driver; and
a plurality of data terminals extending from the data driver,
wherein each of the plurality of gate terminals and each of the plurality of gate lines are electrically connected through the through hole, and each of the plurality of data terminals and each of the plurality of data lines are electrically connected by the through hole.

4. The display apparatus of claim 1, further comprising a second base substrate disposed between the driving circuit unit and the driving circuit controller,
wherein the driving circuit unit and the image embodying unit are disposed on the second base substrate, the driving circuit controller is disposed on the first base substrate, and the driving circuit unit is electrically connected to the driving circuit controller through a through hole formed in the second base substrate.

5. The display apparatus of claim 1, wherein the image embodying unit comprises:
a pixel electrode electrically connected to one thin film transistor of the plurality of thin film transistors;
a liquid crystal layer disposed on the pixel electrode; and
a common electrode forming an electric field in the liquid crystal layer together with the pixel electrode.

6. The display apparatus of claim 5, wherein the pixel electrode comprises a light reflective material.

7. The display apparatus of claim 1, wherein the image embodying unit outputs a hologram image.

8. The display apparatus of claim 1, wherein the image embodying unit is divided in a display area embodying the image and a non-display area adjacent to the display area, and the driving circuit unit and the driving circuit controller are disposed between the display area and the first base substrate.

9. A tiled display apparatus comprising a plurality of display panels arranged along a first direction and a second direction crossing the first direction,
wherein each of the plurality of display panels comprises:
a driving circuit unit including a plurality of gate lines, a plurality of data lines, and a plurality of thin film transistors electrically connected to the plurality of gate lines and the plurality of data lines;
a driving circuit controller disposed under the driving circuit unit and including a gate driver outputting a gate signal to the plurality gate lines, a data driver outputting a data voltage to the plurality of data lines, and an interface circuit unit controlling operation timings of the gate driver and the data driver; and
an image embodying unit disposed on the driving circuit unit and embodying an image in response to a signal received from the driving circuit unit.

10. The tiled display apparatus of claim 9, wherein the driving circuit controller further comprises a plurality of contact terminals extending from the interface circuit unit, and display panels adjacent to each other among the plurality of display panels are electrically connected through the contact terminals.

11. The tiled display apparatus of claim 10, wherein the contact terminals comprises:
a first contact terminal extending along the first direction from the interface circuit unit;
a second contact terminal extending along the second direction from the interface circuit unit;
a third contact terminal extending along a direction completely opposite to the first direction from the interface circuit unit; and
a fourth contact terminal extending along a direction completely opposite to the second direction from the interface circuit unit.

12. The tiled display apparatus of claim 9, further comprising a light source emitting light,
wherein each of the plurality of display panels is a spatial light modulator modulating at least one of phase or amplitude of the light emitted from the light source to output a hologram image.

13. The tiled display apparatus of claim 9, wherein each of the plurality of display panels further comprises a first base substrate and a second base substrate, the driving circuit controller is disposed on the first base substrate, the driving circuit unit is disposed on the driving circuit controller, the image embodying unit is disposed on the driving circuit unit, and the second base substrate is disposed on the image embodying unit.

14. The tiled display apparatus of claim 9, wherein display panels to each other among the plurality of display panels comprise one first base substrate and one second base substrate, and the driving circuit controller of each of the adjacent display panels, the driving circuit unit of each of the adjacent display panels and the image embodying unit of each of the adjacent display panels are disposed between the one first base substrate and the one second base substrate.

15. The tiled display apparatus of claim 9, wherein each of the plurality of display panels further comprises an insulation layer disposed between the driving circuit unit and the driving circuit controller, and the driving circuit unit and the driving circuit controller are electrically connected through a through hole formed in the insulation layer.

16. The tiled display apparatus of claim 15, wherein each of the data lines and each of the gate lines extend along a predetermined direction in a plane defined by the first and second directions, and the through hole extends along a third direction crossing the first and second directions.
